(19) United States
(12) Patent Application Publication
(10) Pub. No.: US 2007/0129194 A1
(43) Pub. Date: Jun. 7, 2007

(54) CHAIN LINK UNIT

(76) Inventor: Daniel WU, Tainan City (TW)

Correspondence Address: OSTROLENK FABER GERB & SOFFEN, 1180 AVENUE OF THE AMERICAS, NEW YORK, NY, 100368403, US

(21) Appl. No.: 11/567,497

(22) Filed: Dec. 6, 2006

(30) Foreign Application Priority Data
Dec. 7, 2005 (TW) 094221277

(51) Int. Cl. F16G 13/02

(52) U.S. Cl. 474/230; 474/231; 474/228

(57) ABSTRACT

A chain link unit includes a lining sleeve extending fittingly through holes in two inner link plates. Two parallel outer link plates abut respectively against outer surfaces of the inner link plates. Each outer link plate has two mounting holes. Each mounting hole in each outer link plate has an enlarged first hole portion disposed adjacent to an inner surface of a corresponding outer link plate and permitting extension of a corresponding end portion of the lining sleeve thereinto. A connecting pin extends through the lining sleeve and two corresponding mounting holes in the outer link plates, and is connected to the outer link plates.

### CROSS-REFERENCE TO RELATED APPLICATION

This application claims priority of Taiwanese Application No. 094221277, filed on Dec. 7, 2005.

### BACKGROUND OF THE INVENTION

1. Field of the Invention

The invention relates to a chain link unit, more particularly to a chain link unit having a lining sleeve.

2. Description of the Related Art

Referring to FIG. 1, a conventional chain includes a plurality of chain link units 1 linked to each other. Each chain link unit 1 includes two parallel inner link plates 11 each having two through holes 111, a lining sleeve 12 having opposite ends engaging fittingly two corresponding ones of the through holes 111 in the inner link plates 11, a roller 13 disposed between the inner link plates 11 and sleeved rotatably on the lining sleeve 12, two parallel outer link plates 14 abutting respectively against outer surfaces of the inner link plates 11, and a connecting pin 15 extending fittingly through the lining sleeve 12 and two corresponding mounting holes 141 in the outer link plates 14, and connected to the outer link plates 14. The lining sleeve 12 has opposite end surfaces 121 that are respectively flush with outer surfaces 112 of the inner link plates 11. In other words, the lining sleeve 12 has a length substantially equal to a distance between the outer surfaces 112 of the inner link plates 11.

In such a configuration, a flat annular gap is formed between each outer link plate 14 and a corresponding one of the end surfaces 121 of the lining sleeve 12 such that significant leakage of lubricant filled between the lining sleeve 12 and the connecting pin 15 through the flat annular gaps cannot be avoided, and that dirt can easily accumulate between the lining sleeve 12 and the connecting pin 15 through the flat annular gaps. As a result, anti-wear properties of each chain link unit 1 are affected adversely.

### SUMMARY OF THE INVENTION

Therefore, the object of the present invention is to provide a chain link unit having improved anti-wear properties.

According to the present invention, a chain link unit comprises:

two parallel inner link plates spaced apart from each other in a first direction, each of the inner link plates having a first inner surface, a first outer surface opposite to the first inner surface, and two through holes extending from the first inner surface to the first outer surface and spaced apart from each other in a second direction that is perpendicular to the first direction;

a lining sleeve having opposite end portions that extend fittingly and respectively through two corresponding ones of the through holes in the inner link plates and that project outwardly from the first outer surfaces of the inner link plates, respectively;

two parallel outer link plates abutting respectively against the first outer surfaces of the inner link plates, each of the outer link plates having a second inner surface facing the first outer surface of a respective one of the inner link plates, a second outer surface opposite to the second inner surface, and two mounting holes extending from the second inner surface to the second outer surface, each of the mounting holes in each of the outer link plates having an enlarged first hole portion that is disposed adjacent to the second inner surface of a corresponding one of the outer link plates and that permits extension of a corresponding one of the end portions of the lining sleeve thereinto; and

a connecting pin extending fittingly through the lining sleeve and two corresponding ones of the mounting holes in the outer link plates and connected to the outer link plates.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary, partly exploded, schematic sectional view of a chain having conventional chain link units;

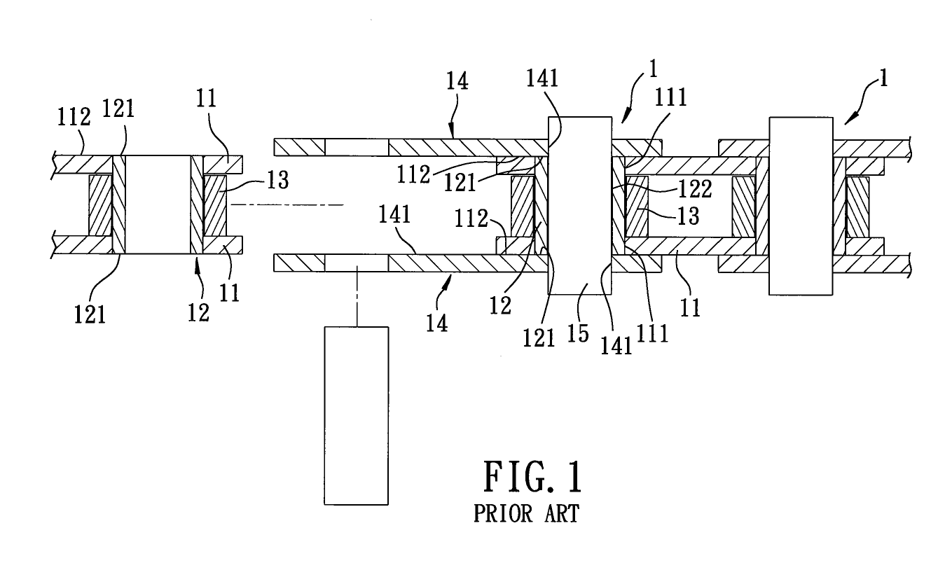

FIG. 2 is a fragmentary, partly exploded, schematic sectional view showing a chain including the first preferred embodiment of a chain link unit according to this invention;

FIG. 3 is an assembled fragmentary schematic view of the chain of FIG. 2;

FIG. 4 is a fragmentary, partly exploded, schematic sectional view showing a chain including the second preferred embodiment of a chain link unit according to this invention;

FIG. 5 is a fragmentary, partly exploded, schematic sectional view showing a chain including the third preferred embodiment of a chain link unit according to this invention;

FIG. 6 is a fragmentary, partly exploded, schematic sectional view showing a chain including the fourth preferred embodiment of a chain link unit according to this invention;

FIG. 7 is a fragmentary, partly exploded, schematic sectional view showing a chain including the fifth preferred embodiment of a chain link unit according to this invention; and

FIG. 8 is a fragmentary, partly exploded, schematic sectional view showing a chain including the sixth preferred embodiment of a chain link unit according to this invention.

### DETAILED DESCRIPTION OF THE PREFERRED EMBODIMENTS

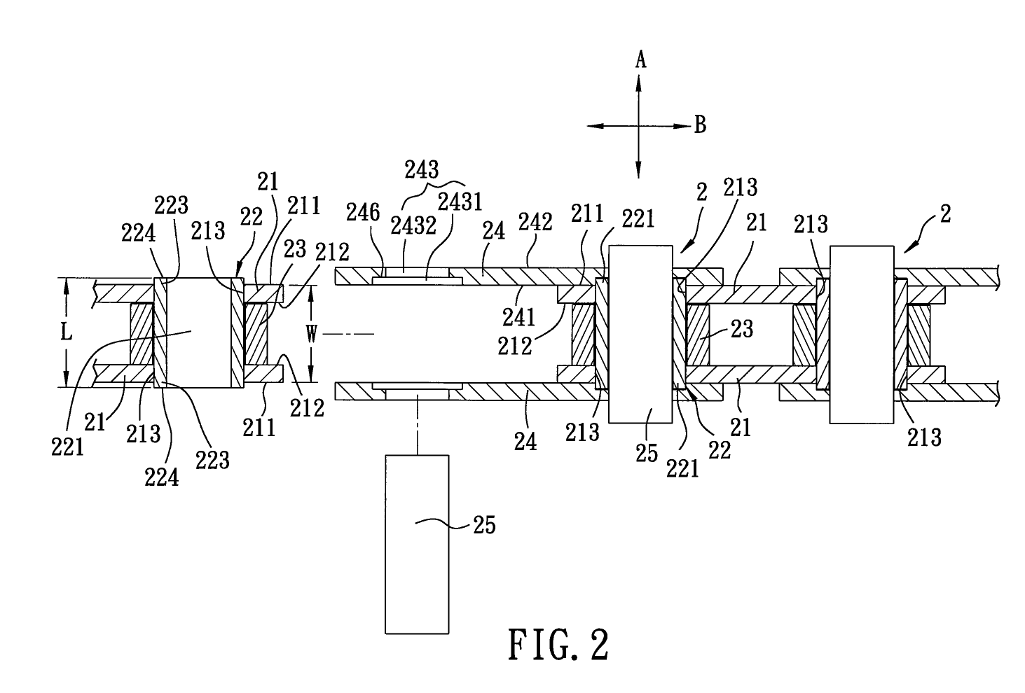

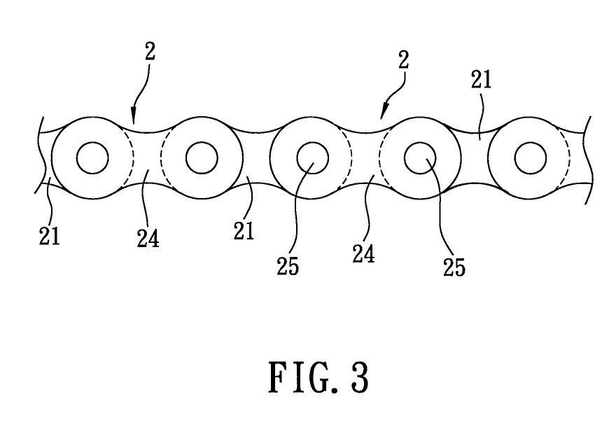

FIGS. 2 and 3 illustrate a chain that includes a plurality of chain link units 2 of the first preferred embodiment according to the present invention. Each chain link unit 2 includes two parallel inner link plates 21, a lining sleeve 22, two parallel outer link plates 24, a connecting pin 25, and a roller 23.

The inner link plates 21 are spaced apart from each other in a first direction (A). Each inner link plate 21 has a first inner surface 212, a first outer surface 211 opposite to the first inner surface 212, and two through holes 213 extending from the first inner surface 212 to the first outer surface 211 and spaced apart from each other in a second direction (B) that is perpendicular to the first direction (A).

The lining sleeve 22 has opposite end portions 221 that extend fittingly and respectively through two corresponding ones of the through holes 213 in the inner link plates 21 and that project outwardly from the first outer surfaces 211 of the inner link plates 21, respectively. In this embodiment, the lining sleeve 22 has a length (L) that is greater than a distance (W) between the first outer surfaces 211 of the inner link plates 21, as shown in FIG. 2.

The outer link plates 24 abut respectively against the first outer surfaces 211 of the inner link plates 21. Each outer link plate 21 has a second inner surface 241 facing the first outer surface 211 of a respective one of the inner link plates 21, a second outer surface 242 opposite to the second inner surface 241, and two mounting holes 243 extending from the second inner surface 241 to the second outer surface 242. For each outer link plate 24, each mounting hole 243 has an enlarged first hole portion 2431 disposed adjacent to the second inner surface 241 and permitting extension of a corresponding one of the end portions 221 of the lining sleeve 22 thereinto, and a narrowed second hole portion 2432 disposed adjacent to the second outer surface 242 and having a diameter that is smaller than that of the first hole portion 2431.

The connecting pin 25 extends fittingly through the lining sleeve 22 and two corresponding ones of the mounting holes 243 in the outer link plates 24, and is connected to the outer link plates 24. In this embodiment, the diameter of the second hole portion 2432 of each mounting hole 243 in each outer link plate 24 is slightly greater than an outer diameter of the connecting pin 25.

The roller 23 is disposed between the inner link plates 21, and is sleeved rotatably on the lining sleeve

In such a configuration, for each chain link unit 2 of this invention, the lining sleeve 22 has a relatively long length as compared to the aforesaid prior art, thereby resulting in an increased contact area between the lining sleeve 22 and the connecting pin 25. As a result, an average pressure acting on a unit area of an outer surface of the connecting pin 25 is reduced, thereby improving anti-wear properties. Furthermore, since the opposite end portions 221 of the lining sleeve 22 extend respectively into the first hole portions 2431 of the two corresponding ones of the mounting holes 243 in the outer link plates 24, a bent annular gap formed between each outer link plate 24 and the corresponding end portion 221 of the lining sleeve 22 can effectively suppress leakage of lubricant filled between the lining sleeve 22 and the connecting pin 25, and can prevent dirt from accumulating between the lining sleeve 22 and the connecting pin 25, thereby further improving anti-wear properties.

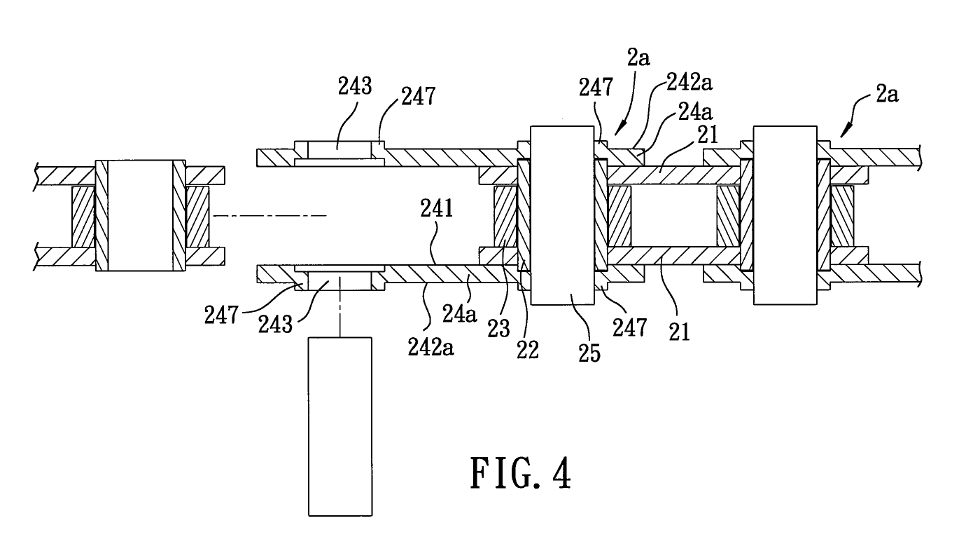

FIG. 4 illustrates a chain including a plurality of chain link units (2a) of the second preferred embodiment according to this invention, which is a modification of the first preferred embodiment. Unlike the first preferred embodiment, for each chain link unit (2a), each outer link plate (24a) further has two circular flanges 247 that extend integrally from the second outer surface (242a) of a corresponding one of the outer link plates (24a) and that define respectively peripheries of the mounting holes 243 in the corresponding one of the outer link plates (24a). It is noted that the circular flanges 247 and the mounting holes 243 of each outer link plate (24a) can be formed by punching. Therefore, the chain link unit (2a) of this invention can be easily fabricated.

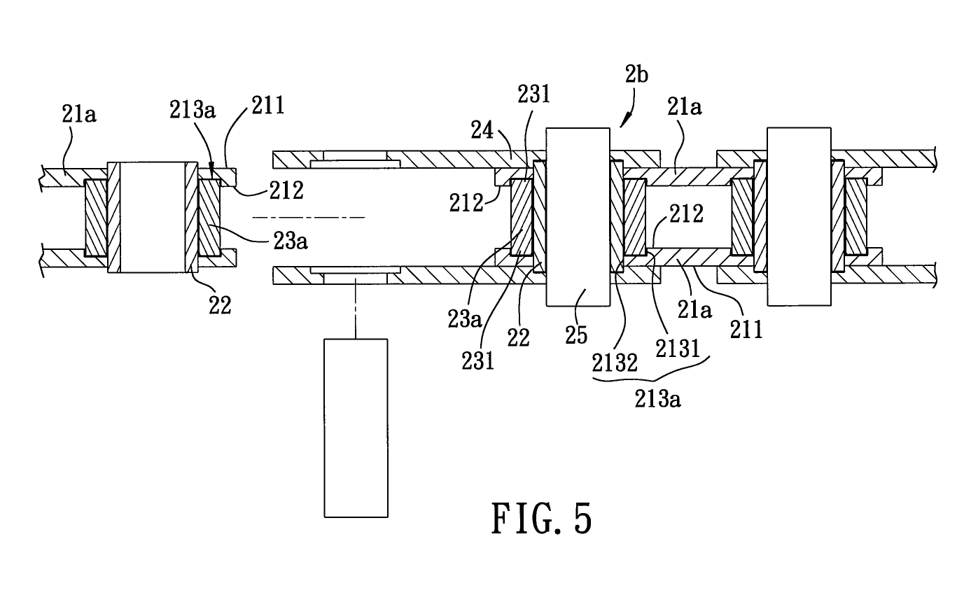

FIG. 5 illustrates a chain including a plurality of chain link units (2b) of the third preferred embodiment according to this invention, which is a modification of the first preferred embodiment. Unlike the first preferred embodiment, for each chain link unit (2b), each through hole (213a) in each inner link plate (21a) has an enlarged first hole portion 2131 adjacent to the first inner surface 212 of a corresponding one of the inner link plates (21a) and permitting extension of a respective one of opposite ends 231 of the roller (23a) thereinto, and a narrowed second hole portion 2132 adjacent to the first outer surface 211 of the corresponding one of the inner link plates (21a) and engaging fittingly the lining sleeve 22. It is noted that since the opposite ends 231 of the roller (23a) extend respectively into the first hole portions 2131 of the two corresponding ones of the through holes (213a) in the inner link plates (21a), a bent annular gap formed between each inner link plate (21a) and the corresponding end 231 of the roller (23a) can prevent dirt from accumulating between the lining sleeve 22 and the roller (23a).

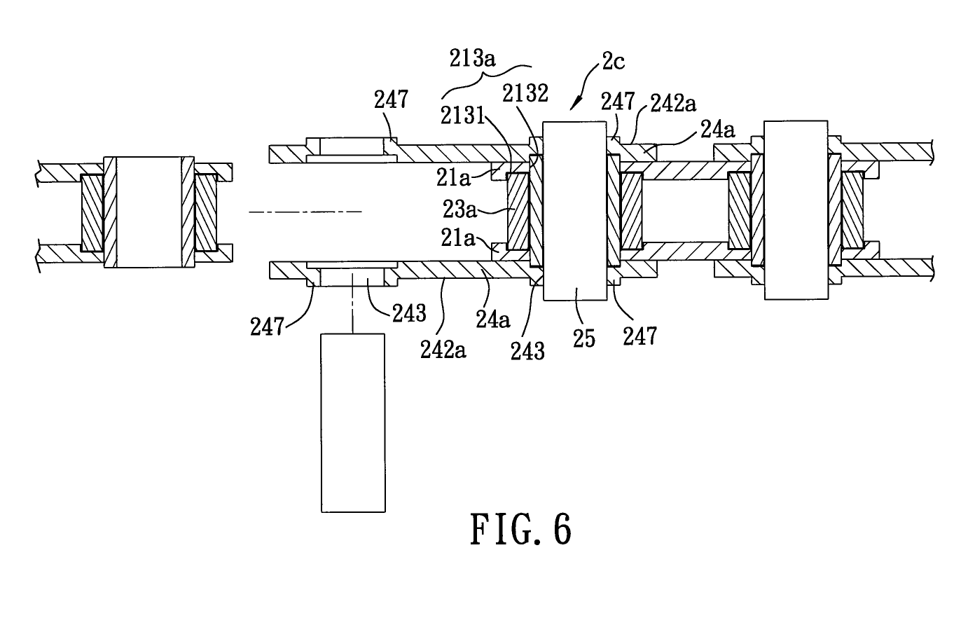

FIG. 6 illustrates a chain including a plurality of chain link units (2c) of the fourth preferred embodiment according to this invention, which is a modification of the first preferred embodiment. Unlike the first preferred embodiment, the outer link plates (24a) have the same configuration as that of the second preferred embodiment of FIG. 4. The inner link plates (21a) and the roller (23a) have the same configurations as those of the third preferred embodiment of FIG. 5.

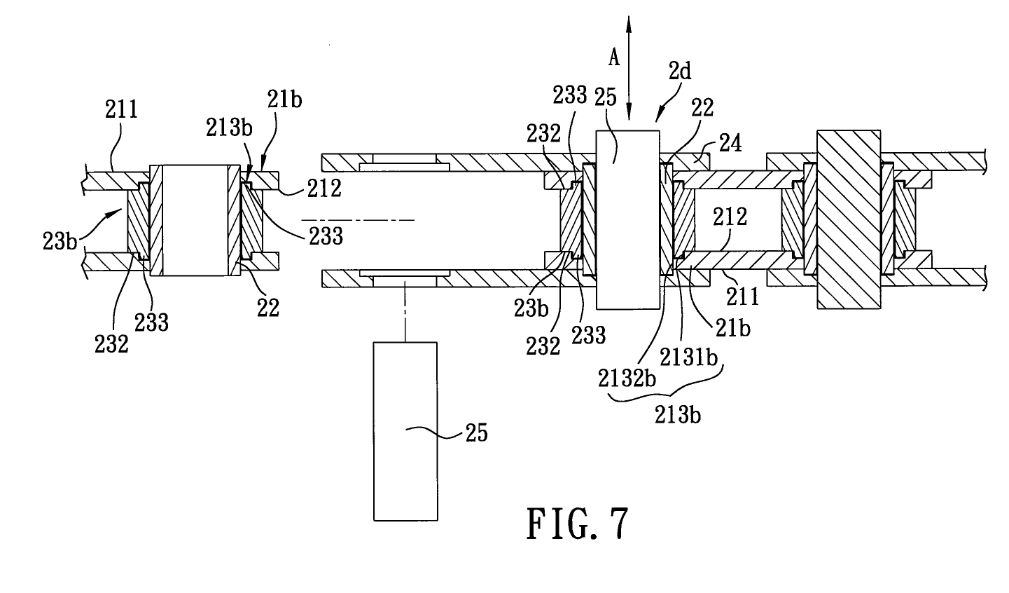

FIG. 7 illustrates a chain including a plurality of chain link units (2d) of the fifth preferred embodiment according to this invention, which is a modification of the first preferred embodiment. Unlike the first preferred embodiment, for each chain link unit (2d), the roller (23b) has two end surfaces 232 opposite to each other in the first direction (A), and two circular flanges 233 that extend integrally and respectively from the end surfaces 232. Each through hole (213b) in each inner link plate (21b) has an enlarged first hole portion (2131b) adjacent to the first inner surface 212 of a corresponding one of the inner link plates (21b) and permitting extension of a respective one of the circular flanges 233 of the roller (23b) thereinto, and a narrowed second hole portion (2132b) adjacent to the first outer surface 211 of the corresponding one of the inner link plates (21b) and engaging fittingly the lining sleeve 22.

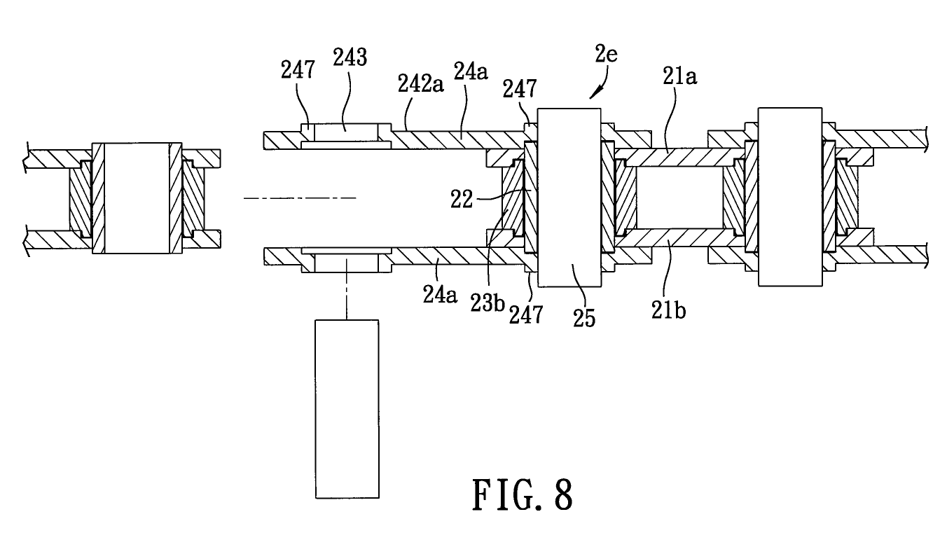

FIG. 8 illustrates a chain including a plurality of chain link units (2e) of the sixth preferred embodiment according to this invention, which is a modification of the fifth preferred embodiment. In this embodiment, each outer link plate (24a) has the same configuration as that of the second preferred embodiment of FIG. 4.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A chain link unit comprising:
two parallel inner link plates spaced apart from each other in a first direction, each of said inner link plates having a first inner surface, a first outer surface opposite to said first inner surface, and two through holes extending from said first inner surface to said first outer surface and spaced apart from each other in a second direction that is perpendicular to the first direction;
a lining sleeve having opposite end portions that extend fittingly and respectively through two corresponding ones of said through holes in said inner link plates and that project outwardly from said first outer surfaces of said inner link plates, respectively;
two parallel outer link plates abutting respectively against said first outer surfaces of said inner link plates, each of said outer link plates having a second inner surface facing said first outer surface of a respective one of said inner link plates, a second outer surface opposite to said second inner surface, and two mounting holes extending from said second inner surface to said second outer surface, each of said mounting holes in each of said outer link plates having an enlarged first hole portion that is disposed adjacent to said second inner surface of a corresponding one of said outer link plates and that permits extension of a corresponding one of said end portions of said lining sleeve thereinto; and
a connecting pin extending fittingly through said lining sleeve and two corresponding ones of said mounting holes in said outer link plates and connected to said outer link plates.

2. The chain link unit as claimed in claim 1, wherein each of said mounting holes in each of said outer link plates further has a narrowed second hole portion disposed adjacent to said second outer surface of the corresponding one of said outer link plates and having a diameter that is smaller than that of said first hole portion of a corresponding one of said mounting holes and that is slightly greater than an outer diameter of said connecting pin.

3. The chain link unit as claimed in claim 1, wherein each of said outer link plates further has two circular flanges that extend integrally from said second outer surface of the corresponding one of said outer link plates and that define respectively peripheries of said mounting holes in the corresponding one of said outer link plates.

4. The chain link unit as claimed in claim 1, further comprising a roller disposed between said inner link plates and sleeved rotatably on said lining sleeve.

5. The chain link unit as claimed in claim 4, wherein each of said through holes in each of said inner link plates has an enlarged first hole portion adjacent to said first inner surface of a corresponding one of said inner link plates and permitting extension of a respective one of opposite ends of said roller thereinto, and a narrowed second hole portion adjacent to said first outer surface of the corresponding one of said inner link plates and engaging fittingly said lining sleeve.

6. The chain link unit as claimed in claim 5, wherein each of said outer link plates further has two circular flanges that extend integrally from said second outer surface of the corresponding one of said outer link plates and that define respectively peripheries of said mounting holes in the corresponding one of said outer link plates.

7. The chain link unit as claimed in claim 4, wherein:
said roller has two end surfaces opposite to each other in the first direction, and two circular flanges that extend integrally and respectively from said end surfaces; and
each of said through holes in each of said inner link plates has an enlarged first hole portion adjacent to said first inner surface of a corresponding one of said inner link plates and permitting extension of a respective one of said circular flanges of said roller thereinto, and a narrowed second hole portion adjacent to said first outer surface of the corresponding one of said inner link plates and engaging fittingly said lining sleeve.

8. The chain link unit as claimed in claim 7, wherein each of said outer link plates further has two circular flanges that extend integrally from said second outer surface of the corresponding one of said outer link plates and that define respectively peripheries of said mounting holes in the corresponding one of said outer link plates.
